(19) United States
(12) Patent Application Publication
(10) Pub. No.: US 2016/0109312 A1
(43) Pub. Date: Apr. 21, 2016

(54) PRESSURE GAUGE WITH DIGITAL DISPLAY

(71) Applicant: CLARK EQUIPMENT COMPANY, Statesville, NC (US)

(72) Inventors: Shane Dyson, Statesville, NC (US); D. Chuck Burton, Statesville, NC (US)

(21) Appl. No.: 14/514,740

(22) Filed: Oct. 15, 2014

(51) Int. Cl. G01L 7/04; G01L 19/08

(52) U.S. Cl. CPC G01L 7/04; G01L 19/083

(57) ABSTRACT

A measuring instrument for use with a gas compression system includes a housing having a face, a rear panel, and a wall extending between the rear panel and the face to define an instrument space. A curved tube includes a first end connected to a source of pressure. The curved tube is disposed within the instrument space. An indicator needle is coupled to a second end of the curved tube and is movable with respect to the face in response to changes in pressure from the pressure source. The needle and the face cooperate to indicate a measured pressure of the source of pressure. An electronic display is disposed within the instrument space and is visible through an aperture formed in the face. The electronic display is operable to display data unrelated to the pressure of the source of pressure.

### BACKGROUND

The present invention relates to a pressure gauge that includes an integrated digital display, and more particularly to a mechanical pressure gauge including an incorporated digital display.

Air compressors and in particular large air compressors (greater than 500 cubic feet per minute) include a pressure gauge positioned to measure the output pressure of the compressor. These large air compressors also often include other sensors and measuring devices that monitor various operating parameters of the compressor. Typically, these sensors are digital or analog electric sensors. However, it is important to provide a mechanical pressure gauge that can measure and indicate the pressure of the system even when power is not provided.

### SUMMARY

In one construction, the invention provides a measuring instrument for use with a gas compression system. The measuring instrument includes a housing including a face, a rear panel, and a wall extending between the rear panel and the face to define an instrument space. A curved tube includes a first end connected to a source of pressure. The curved tube is disposed within the instrument space. An indicator needle is coupled to a second end of the curved tube and is movable with respect to the face in response to changes in pressure from the pressure source. The needle and the face cooperate to indicate a measured pressure of the source of pressure. An electronic display is disposed within the instrument space and is visible through an aperture formed in the face. The electronic display is operable to display data unrelated to the pressure of the source of pressure.

In another construction, the invention provides a measuring instrument for use with a gas compression system that includes a plurality of sensors each measuring one of a plurality of operating parameters, each of the sensors delivering a signal indicative of the measured parameter to a sensor bus. The measuring instrument includes a housing including a rear panel and a wall extending from the rear panel to define an instrument space A face includes measurement indicia and an aperture, the face coupled to the wall and spaced apart from the rear panel to enclose the instrument space. A mechanically-operated pressure sensor is positioned within the instrument space and includes an indicator that is movable with respect to the face and that cooperates with the measurement indicia to indicate a measured pressure. A circuit board is disposed within the instrument space and electrically connected to the sensor bus and an electronic display is disposed within the instrument space and is visible through the aperture. The electronic display is connected to the circuit board and is operable to display data related to the plurality of operating parameters.

Other aspects of the invention will become apparent by consideration of the detailed description and accompanying drawings.

### BRIEF DESCRIPTION OF THE DRAWINGS

FIG. 1 is a perspective view of a pressure gauge embodying the invention;

FIG. 2 is a schematic illustration of a gas compression system including the pressure gauge of FIG. 1;

FIG. 3 is an exploded view of the pressure gauge of FIG. 1; and

FIG. 4 is a rear view of the pressure gauge of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

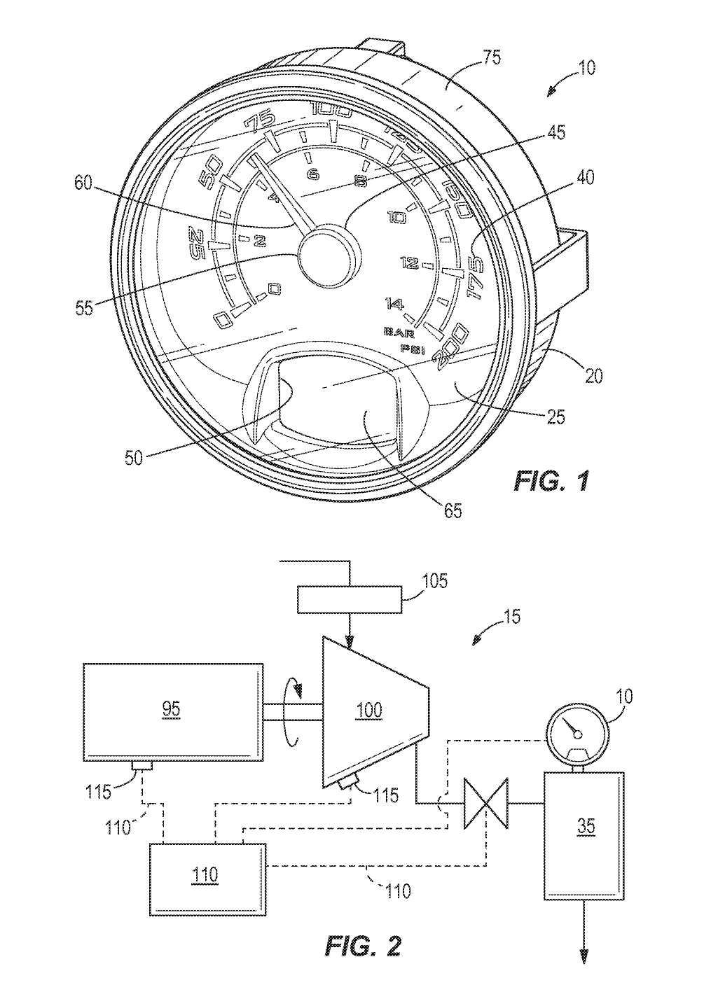

FIG. 1 illustrates a pressure gauge 10 suitable for use in a pressurized system 15 to indicate the pressure of the system 15, or a portion of the system. The illustrated pressure gauge 10 includes a housing 20, a faceplate 25, and an attachment member 30. The attachment member 30 passes through the housing 20 and is arranged to provide a fluid tight connection with another component such as a pipe or pressurized tank 35 (shown in FIG. 2). In the illustrated construction, the attachment member 30 includes a threaded member arranged to engage a threaded aperture. Of course, other arrangements are possible. In addition, the illustrated attachment member 30 functions as a gas connection between the pressure gauge 10 and the component or tank 35 that is being measured.

The faceplate 25 includes indicia 40 that are used to indicate the value of the pressure being measured by the gauge 10. In addition, the faceplate 25 includes a central aperture 45 and a rectangular aperture 50. The central aperture 45 allows for the passage of a shaft 55 that connects to an indicator needle 60 that rotates with the shaft 55 to indicate the measured pressure. The rectangular aperture 50 allows for the passage or exposure of a digital display 65 that will be discussed in greater detail below.

The housing 20 includes a rear panel 70 and a cylindrical wall 75 that extends from the rear panel 70. FIG. 4 illustrates one arrangement of a rear panel 70 that includes a power connector 80 and a data connector 85 in the form of a serial data interface connector. In some constructions, the attachment member 30 extends from the rear panel 70 rather than through the housing 20. Of course, other arrangements are possible and contemplated. The faceplate 25, the rear panel 70, and the cylindrical wall 75 cooperate to define an instrument space 90 therein. The housing 20 provides some protection to the components within the instrument space 90. In some constructions, a glass plate or other transparent member is positioned on top of the faceplate 25 to protect or cover the faceplate 25. FIG. 1 illustrates one shape and arrangement of a pressure gauge 10 with other arrangements being possible.

FIG. 2 illustrates one example of the compressor system 15 that utilizes the pressure gauge 10 of FIG. 1. The system 15 includes an engine 95 or other prime mover that drives a compressor 100. In the illustrated construction, the compressor 100 draws atmospheric air through an air filter 105 and into the compressor 100. The compressor 100 compresses the air and discharges the compressed air to a point of use. In the construction of FIG. 2, the point of use includes the tank 35 that stores the pressurized air for use. The pressure gauge 10 of FIG. 1 is connected to the tank 35 to measure the air pressure within the tank 35.

The system of FIG. 2 includes a control area network bus (CAN bus) 110 that interconnects the various components of the system 15 and collects data related to any number of measured parameters from each of the components. As illustrated in FIG. 2, data is collected from sensors 115 on the engine 95, the compressor 100, and any other component that may include a CAN bus interface. In addition, the CAN bus 110 can be used to send data or other signals to these components and others such as the pressure gauge 10 as desired. Collected data could include, engine temperatures, engine speed, compressor intake pressure, exhaust pressure, flow rates, and the like.

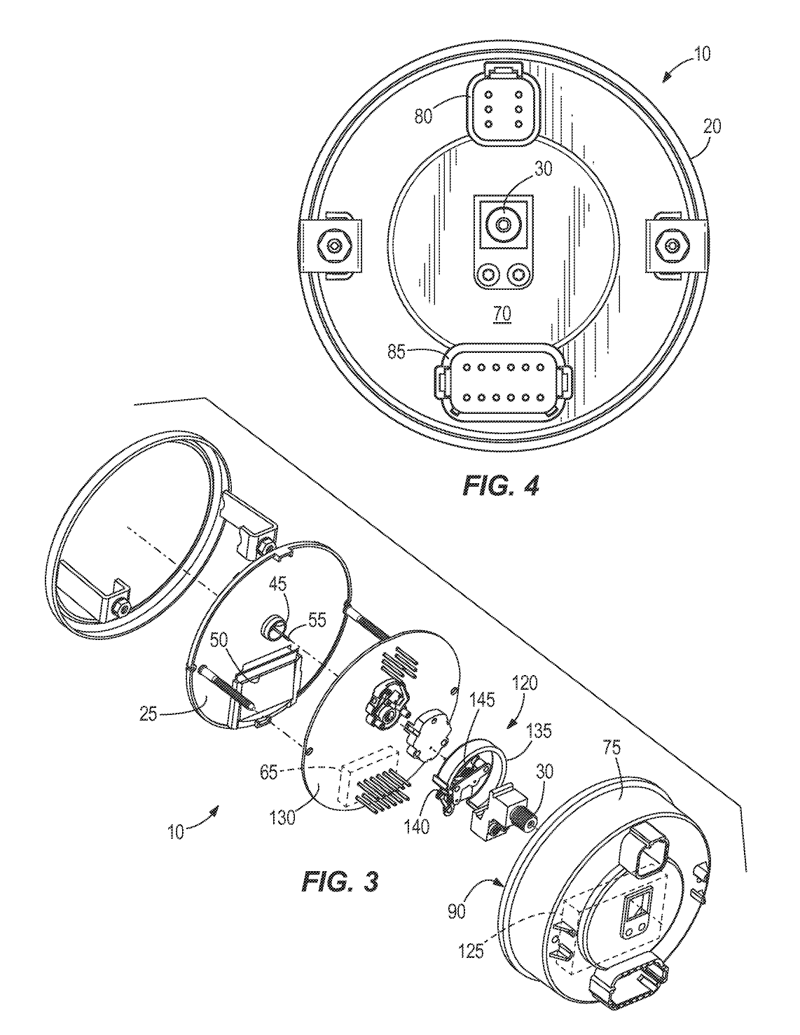

As illustrated in FIG. 3 the pressure gauge 10 includes a Bourdon-style pressure sensor 120, a power supply 125, and a circuit board 130. The Bourdon-style pressure sensor 120 includes a curved flexible tube 135 that has one fixed end and a second end attached to a mechanism 140. The mechanism 140 drives a pinion 145 that in turn rotates the shaft 55 that extends through the faceplate 25 to rotate the indicator needle 60. FIG. 3 illustrates one arrangement of the mechanical pressure sensor 120. However, other Bourdon-style sensors 120 as well as other arrangements of mechanical sensors are possible and well-suited to the present invention.

The power supply 125 could include a battery pack or other power storage medium or could include a standard AC power supply. In some constructions, the power supply 125 receives a standard AC current and includes a backup battery supply that is capable of providing power when the AC supply is not available. The power supply 125 is selected and arranged to provide power to the circuit board 130 as may be required.

The circuit board 130 supports the digital display 65, receives power from the power supply 125, and communicates with the CAN bus 110. In preferred constructions, a direct wired communication with the CAN bus 110 is employed. However, other constructions could employ wireless communication if desired. In the illustrated arrangement of the pressure gauge 10, data is transmitted to the pressure gauge 10 via the CAN bus 110. However, the pressure gauge 10 does not collect any digital or electronic data and as such does not transmit data to the CAN bus 110. Of course, other constructions could convert the mechanical pressure data to a digital signal and transmit that data to the CAN bus 110 if desired.

The digital display 65 could include an LED display or LCD display or any other type of display desired. The display 65 is arranged to display any data that is available via the CAN bus 110. Thus, the pressure gauge 10 can display data related to the engine 95, the compressor 100 or any other aspect of the compressor system 15. In some constructions, the display 65 scrolls through the various parameters available on the CAN bus 110 with other constructions including user controls that allow for the selection of a particular value to be displayed. In still other constructions, the user is able to select a subset of the available parameters for display. In still other constructions, one subset of data is displayed for a predetermined period and then a second subset of data is displayed for a second predetermined period. For example, one construction displays engine-related data (a first subset of data) for 30 seconds then switches to compressor-related data (a second subset of data) which is displayed for 30 seconds.

In operation, the pressure gauge 10 is connected to the tank 35 or other component that contains the pressurized fluid to be measured. In some constructions, the gauge 10 is directly connected to the component, with other constructions including a tube that connects the pressure gauge 10 to a remote component so that the pressure gauge 10 can be mounted near the system controls or at another convenient location. The pressure gauge 10 measures the pressure using the mechanical Bourdon-style sensor 120 and displays the pressure measured using the indicator needle 60 and the faceplate 25. The digital display 65 cycles through or scrolls through the various parameters to be displayed to show the operating values of the other components within the system 15. Should electrical power be lost, the digital display 65 no longer displays values. However, the mechanical pressure sensor 120 will continue to measure and display the pressure within the component being measured. Thus, the invention provides a pressure gauge 10 that is able to accurately display the pressure of the component being measured without need for power, while simultaneously displaying other measured parameters when power is available.

Various features and advantages of the invention are set forth in the following claims.

What is claimed is:

1. A measuring instrument for use with a gas compression system, the measuring instrument comprising:
a housing including a face, a rear panel, and a wall extending between the rear panel and the face to define an instrument space;
a curved tube including a first end connected to a source of pressure, the curved tube disposed within the instrument space;
an indicator needle coupled to a second end of the curved tube and movable with respect to the face in response to changes in pressure from the source of pressure, the needle and the face cooperating to indicate a measured pressure of the source of pressure; and
an electronic display disposed within the instrument space and visible through an aperture formed in the face, the electronic display operable to display data unrelated to the pressure of the source of pressure.

2. The measuring instrument of claim 1, further comprising a circuit board disposed within the housing.

3. The measuring instrument of claim 2, wherein the circuit board is electrically connected to a CAN bus to receive signals indicative of a plurality of measured parameters of the gas compression system.

4. The measuring instrument of claim 3, wherein the circuit board is electrically connected to the electronic display and is operable to deliver the data to the electronic display for display, the data being related to the signals indicative of the plurality of measured parameters of the gas compression system to the electronic display.

5. The measuring instrument of claim 4, wherein the circuit board is operable to display a first subset of data indicative of a first portion of the plurality of measured parameters for a first predetermined period of time, and second subset of data indicative of a second portion of the plurality of measured parameters for a second predetermined period of time.

6. The measuring instrument of claim 1, wherein the electronic display is an LCD display.

7. The measuring instrument of claim 1, wherein the wall of the housing is substantially cylindrical.

8. The measuring instrument of claim 1, wherein the rear panel includes a power connector, a data connector, and a gas connection.

9. The measuring instrument of claim 1, wherein the data connector is a serial data interface connector.

10. A measuring instrument for use with a gas compression system that includes a plurality of sensors each measuring one of a plurality of operating parameters, each of the sensors delivering a signal indicative of the measured parameter to a sensor bus, the measuring instrument comprising:
a housing including a rear panel and a wall extending from the rear panel to define an instrument space;
a face including measurement indicia and an aperture, the face coupled to the wall and spaced apart from the rear panel to enclose the instrument space;
a mechanically-operated pressure sensor positioned within the instrument space and including an indicator that is movable with respect to the face and that cooperates with the measurement indicia to indicate a measured pressure;
a circuit board disposed within the instrument space and electrically connected to the sensor bus; and
an electronic display disposed within the instrument space and visible through the aperture, the electronic display connected to the circuit board and operable to display data related to the plurality of operating parameters.

11. The measuring instrument of claim 10, wherein the circuit board is electrically connected to a CAN bus to receive signals indicative of a plurality of measured parameters of the gas compression system.

12. The measuring instrument of claim 10, wherein the circuit board is operable to display a first subset of data indicative of a first portion of the plurality of measured parameters for a first predetermined period of time, and second subset of data indicative of a second portion of the plurality of measured parameters for a second predetermined period of time.

13. The measuring instrument of claim 10, wherein the electronic display is an LCD display.

14. The measuring instrument of claim 10, wherein the wall of the housing is substantially cylindrical.

15. The measuring instrument of claim 10, wherein the rear panel includes a power connector, a data connector, and a gas connection.

16. The measuring instrument of claim 10, wherein the data connector is a serial data interface connector.
